(19) United States
(12) Patent Application Publication
(10) Pub. No.: US 2012/0057207 A1
(43) Pub. Date: Mar. 8, 2012

(54) IMAGE FORMING APPARATUS AND TRACE DATA STORING METHOD THEREFOR, AND COMPUTER-READABLE STORAGE MEDIUM

(75) Inventor: Norihisa Shiraishi, Shizuoka (JP)

(73) Assignee: TOSHIBA TEC KABUSHIKI KAISHA, Tokyo (JP)

(21) Appl. No.: 13/184,652

(22) Filed: Jul. 18, 2011

(30) Foreign Application Priority Data
Sep. 3, 2010 (JP) 2010-197938

(51) Int. Cl. G06K 15/02

(52) U.S. Cl. 358/3.24

(57) ABSTRACT

An image forming apparatus, which includes an image forming unit configured to form an image on a recording medium and generate trace data. The image forming apparatus further includes a first storing unit, a second storing unit, and a control unit configured to allow the trace data generated from the image forming unit to be stored in the first storing unit, and further configured to allow the trace data stored in the first storing unit to be stored in the second storing unit upon occurrence of an error.

### CROSS-REFERENCE TO RELATED APPLICATIONS

This application is based upon and claims the benefit of priority from Japanese Patent Application No. 2010-197938, filed on Sep. 3, 2010, the entire contents of which are incorporated herein by reference.

### FIELD

Embodiments described herein relate generally to an image forming apparatus such as a printer, and a trace data storing method for use in the image forming apparatus.

### BACKGROUND

An image forming apparatus such as a printer is operated by cooperation between various hardware and software components. Such a configuration may cause a variety of errors or other problems in addition to software errors. Addressing such problems requires, in some instances, trace data containing records on the history of operations performed by the image forming apparatus.

In some image forming apparatus, errors or other problems are recorded by a printer driver running on a server or a personal computer connected to the image forming apparatus.

There is also an approach of sampling data, which is being received and transmitted to/from a printer through a network, and storing the sampled data in memory.

Unfortunately, in the approach which records the contents of the errors or other problems by using the printer driver running on a server or personal computer, the contents of the errors or other problems may not be recorded properly due to a communication failure.

In addition, the approach, which samples data received and transmitted to/from a printer through a network, fails to record errors or other problems occurring in the printer itself.

Accordingly, an approach is required to analyze errors or other problems occurring in the printer itself.

### BRIEF DESCRIPTION OF THE DRAWINGS

FIG. 1 is a block diagram showing a configuration of an image forming apparatus according to an illustrative embodiment.

FIG. 2 is a flowchart explaining the operation of an image forming apparatus according to an illustrative embodiment.

FIG. 3 is a flowchart explaining a trace data storing sub-routine which is performed in an image forming apparatus according to an illustrative embodiment.

FIG. 4 is a flowchart explaining a trace data writing sub-routine which is performed in an image forming apparatus according to an illustrative embodiment.

FIG. 5 is a diagram showing a data storing area.

FIG. 6 is a detailed diagram showing a header of data stored in a first storing area in RAM.

FIG. 7 is a diagram showing an exemplary configuration of trace data.

### DETAILED DESCRIPTION

According to one embodiment, an image forming apparatus includes an image forming unit configured to form an image on a recording medium and generate trace data. The image forming apparatus further includes a first storing unit, a second storing unit, and a control unit configured to allow the trace data generated from the image forming unit to be stored in the first storing unit, and further configured to allow the trace data stored in the first storing unit to be stored in the second storing unit upon occurrence of an error.

Embodiments will now be described in detail with reference to the drawings.

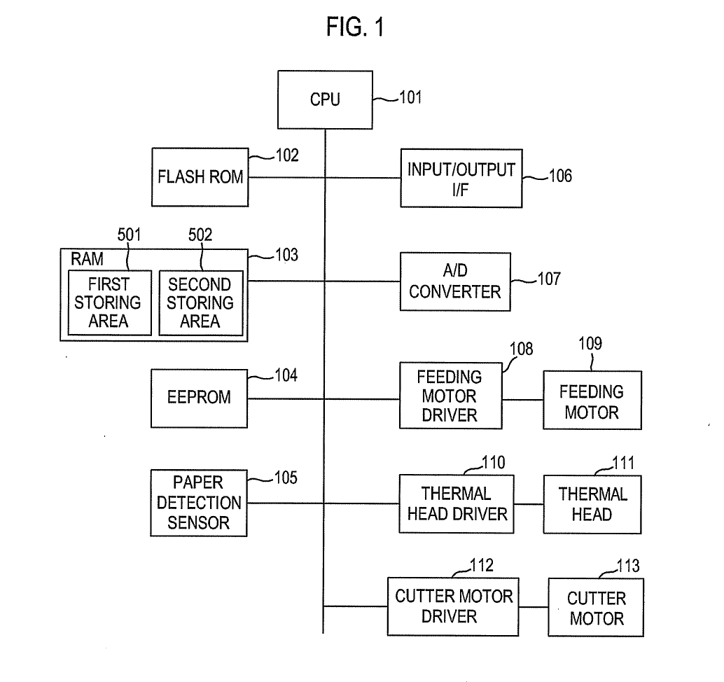

FIG. 1 is a block diagram showing an example of an image forming apparatus according to an illustrative embodiment. The image forming apparatus may include an electronic image forming apparatus (e.g., a laser printer), an inkjet printer, a dot printer, a thermal printer, or the like. In this embodiment, a description will be made as to the thermal printer as one example.

As shown in FIG. 1, the image forming apparatus includes a CPU 101 as a control unit configured to control the entire operation of the image forming apparatus, a flash ROM 102 as a rewritable non-volatile storage device, a RAM 103 including a first storing area 501 (as a first storing device) and a second storing area 502 (as a second storing device), and an EEPROM 104 as a rewritable storing device.

The image forming apparatus further includes a paper detection sensor 105 configured to detect the presence or absence of a recording medium, an input/output interface (I/F) 106 configured to interface with higher-level equipment, and an analog-to-digital (A/D) converter 107 configured to convert analog data into digital data.

The image forming apparatus further includes a feeding mechanism to feed the recording medium therethrough. The image forming apparatus further includes a feeding motor 109 configured to provide a driving force to the feeding mechanism which feeds the recording medium, and a feeding motor driver 108 configured to control the feeding motor 109. The image forming apparatus further includes a thermal head 111 (as an image forming unit) configured to form an image on the recording medium, and a thermal head driver 110 configured to control the thermal head 111. The image forming apparatus further includes a cutter motor 113 configured to provide a driving force to a cutter which cuts out the recording medium, and a cutter motor driver 112 configured to control the cutter motor 113.

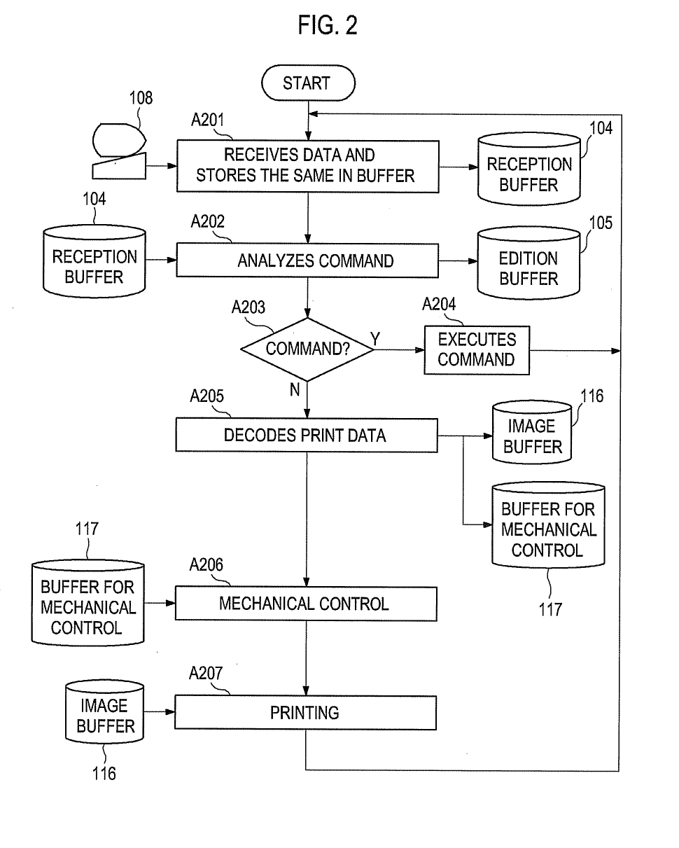

FIG. 2 is a flowchart explaining the operation of an image forming apparatus according to an illustrative embodiment. As shown in FIG. 2, in Act A201, the image forming apparatus receives data from a higher-level equipment 118 such as a personal computer, and stores the data in a reception buffer 114 such as the RAM 103.

In Act A202, the image forming apparatus sequentially reads the reception data from the reception buffer 114. Then, the image forming apparatus analyzes a command contained in the reception data, and outputs the analysis result to an edition buffer 115 such as the RAM 103.

In Act A203, the image forming apparatus reads the reception data stored in the edition buffer 115 and determines whether the reception data is the command. If the determination result is YES at Act A203, the process goes to Act A204 where the image forming apparatus performs an operation associated with the command, and then the process returns to Act A201. If the determination result is NO at Act A203 (i.e., the image forming apparatus determines that the reception data is not a command, the process goes to Act A205.

In Act A205, the image forming apparatus extracts print data from the reception data, stores image data (e.g., contained in the print data) in an image buffer 116 such as the RAM 103 and further stores mechanical control data (e.g., contained in the print data) in a buffer for mechanical control 117 such as the RAM 103.

In Act A206, the image forming apparatus reads the mechanical control data from the buffer for mechanical control 117 to mechanically operate hardware components.

In Act A207, the image forming apparatus reads the image data from the image buffer 116 to perform printing on the recording medium, and then the process returns to Act 201.

These operations may be controlled by a software program. Such a software program may include a sub-routine which outputs trace data (e.g., a history of main operations) to a storage device after major operations are performed.

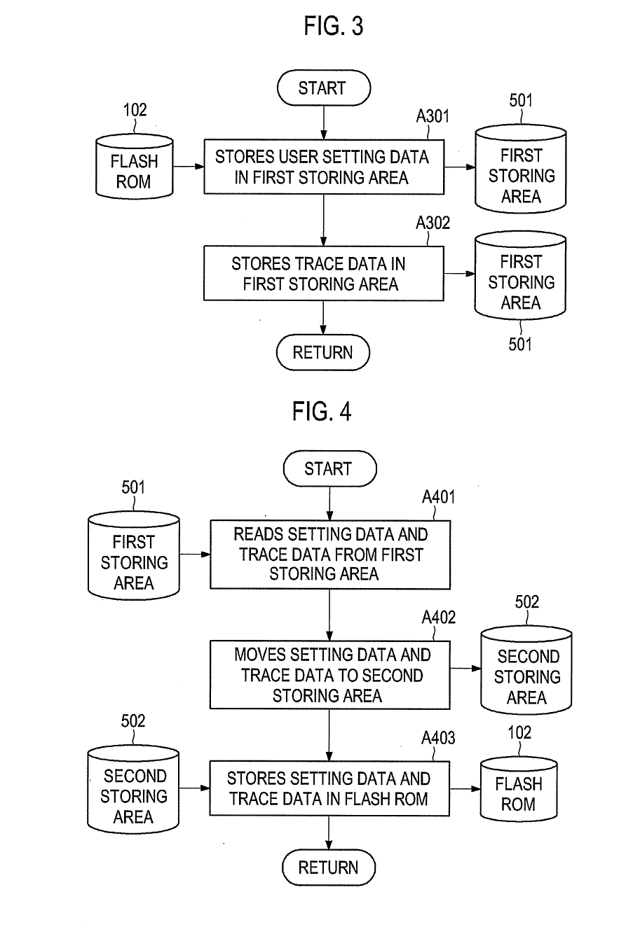

FIG. 3 is a flowchart explaining a trace data storing sub-routine which is performed in the image forming apparatus according to an illustrative embodiment. As shown in FIG. 3, in Act A301, the image forming apparatus reads user setting data from the flash ROM 102 to store the same in the first storing area 501 of the RAM 103.

In Act A302, the image forming apparatus stores trace data in the first storing area 501 of the RAM 103. Thereafter, the process returns to a program which has called the trace data storing sub-routine.

The trace data stored in the first storing area 501 of the RAM 103 is written in the flash ROM 102 by a trace data writing sub-routine that is called upon the occurrence of an error or other problems.

FIG. 4 is a flowchart explaining a trace data writing sub-routine which is performed in the image forming apparatus according to an illustrative embodiment. As shown in FIG. 4, in Act A401, the image forming apparatus reads the user setting data and the trace data from the first storing area 501 of the RAM 103.

In Act A402, the image forming apparatus moves the user setting data and the trace data read in Act A401 to the second storing area 502 of the RAM 103. With this arrangement, subsequent trace data, which may be generated during a time period after the data movement (i.e., Act A402) until a subsequent Act A403 is completed, can be stored in the first storing area 501 of the RAM 103.

In Act A403, the image forming apparatus extracts the user setting data and the trace data from the second storing area 502 of the RAM 103 and stores the same in the flash ROM 102.

From the flash ROM 102, the user setting data and the trace data may be read for use in analyzing a reason for error or other problems. Specifically, in response to a read command provided from the higher-level equipment 118, the CPU 101 of the image forming apparatus extracts the user setting data and the trace data stored in the flash ROM 102 and sends the same to the higher-level device 118.

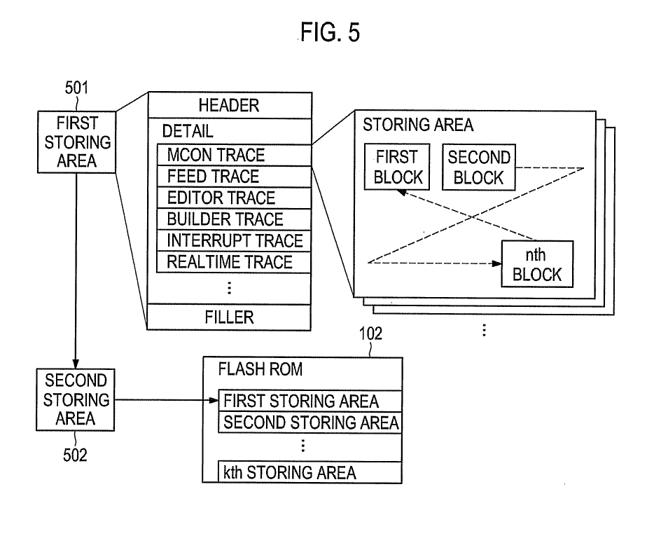

FIG. 5 illustrates a detailed configuration of the data storing area as described above. As shown in FIG. 5, the first storing area 501 of the RAM 103 may have a storage capacity of 64K byte and may be segmented into a plurality of sub-areas each storing data fields such as Header, Detail, Filler as a preserved area, or the like.

In one embodiment, the sub-area “Detail” is further divided into a plurality of segments each corresponding to each module which writes trace data. The module may include, for example, Mcon (mechanical controller), Feed (feed motor controller), Editor (print data analysis module), Builder (image builder), Interrupt (module for interrupting printing operation), Realtime (module for storing current status of respective components when an error occurs), or the like. By way of non-limiting example, the module may be varied depending on the configuration of software embedded in the image forming apparatus.

As shown in FIG. 5, a storing area allocated to each module is further divided into a plurality of blocks. Taking the module “Mcon” for instance, the image forming apparatus stores trace data in a sequential order (e.g., starting from a first block to a n-th block) when the trace data of “Mcon” is generated. If the trace data is stored up to the n-th block and subsequently new trace data is generated, the image forming apparatus sequentially performs overwriting from the first block. Accordingly, even if the storing area is full of trace data, subsequently generated trace data may be stored in the storing area.

As described above, through the use of the trace data writing sub-routine which is called every time an error or other problems are generated, the image forming apparatus extracts the contents of data stored in the first storing area 501 of the RAM 103 and moves (or stores) the same to the second storing area 502 of the RAM 103. Further, the image forming apparatus stores the data moved to the second storing area 502 of the RAM 103 in a first storing area of the flash ROM 102.

Thereafter, upon occurrence of subsequent errors or other problems, the image forming apparatus moves (or stores) the data stored in the second storing area 502 of the RAM 103 in a second storing area of the flash ROM 102.

In this way, if data is stored up to a k-th block of the flash ROM 102, upon occurrence of a subsequent error or other problems, the image forming apparatus extracts the data moved to the second storing area 502 of the RAM 103 and overwrites the same in a sequential order starting from the first storing area of the flash ROM 102.

With this arrangement, the image forming apparatus is capable of storing user setting data and trace data associated with the last generated errors or problems (e.g., at the k-th time) at any time.

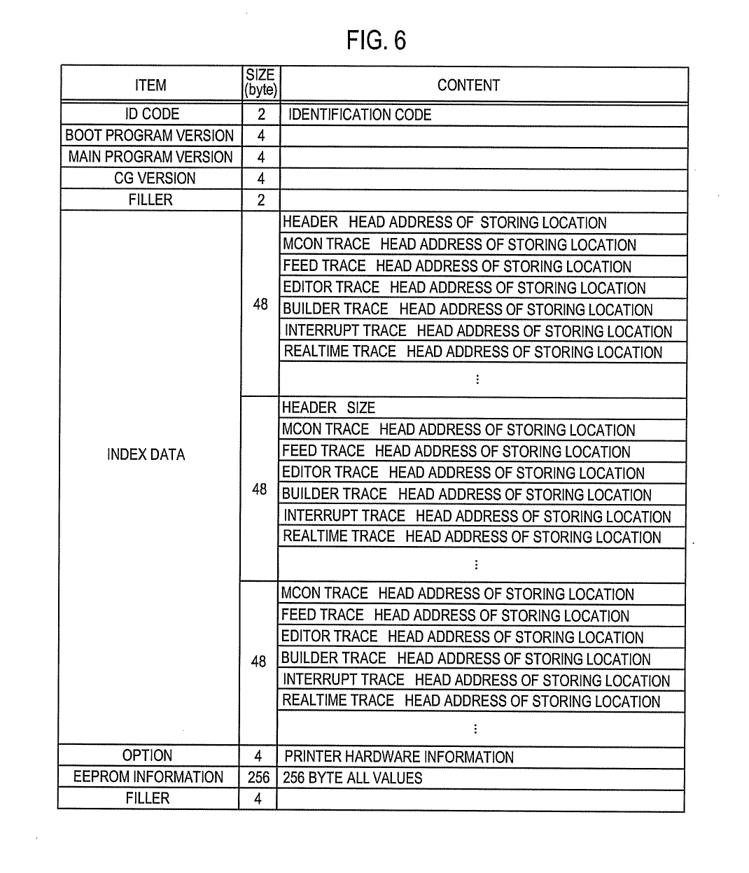

FIG. 6 illustrates a detailed configuration of a header of data stored in the first storing area 501 of the RAM 103. As shown in FIG. 6, the image forming apparatus stores as header information, for example, ID code, Boot Program version, Main Program version, CG (character generator) version, Index Data, Option (e.g., data representing any optional functions), EEPROM Information indicating all information stored in the EEPROM, or the like.

The “Index Data” may include a head address of a storing location allocated for every module, a size per one block, the latest block number, or the like.

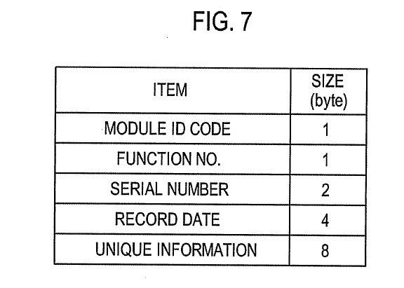

FIG. 7 illustrates an exemplary configuration of trace data. As shown in FIG. 7, the trace data may include various items, for example, Module ID Code, Function No., Serial Number for trace data, Record Date as a time stamp, Unique Information as detail information for the trace data, or the like.

Since the trace data includes the Record Date, the image forming apparatus may sort the trace data based on the Record Date while reading and analyzing the trace data from the flash ROM 102, so that the trace data can be reviewed in the order of occurrence of related events.

As described above, the image forming apparatus according to the above embodiment includes the first and second storing areas 501 and 502 of the RAM 103, the flash ROM 102 as a writable non-volatile storage device. The image forming apparatus further includes the control unit configured to allow the trace data to be stored in the first storing area 501, move (or, shift) the trace data to the second storing area 502 upon the occurrence of an error, and then store the moved (or, shifted) trace data in the flash ROM 102.

Accordingly, the image forming apparatus can record and maintain trace data in its storage devices.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable recording medium storing the program therein. A form of the computer readable recording medium can be any form as long as the computer readable recording medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an image forming unit configured to form an image on a recording medium and generate trace data;
a first storing unit;
a second storing unit; and
a control unit configured to allow the trace data generated from the image forming unit to be stored in the first storing unit, and further configured to allow the trace data stored in the first storing unit to be stored in the second storing unit upon occurrence of an error.

2. The apparatus of claim 1, wherein the first storing unit includes a first and a second storing area,
wherein the control unit is configured to allow the trace data to be stored in the first storing area of the first storing unit, and upon occurrence of the error, move the trace data stored in the first storing area of the first storing unit to the second storing area of the first storing unit, and further configured to move the trace data stored in the second storing area of the first storing unit to the second storing unit.

3. The apparatus of claim 1, wherein the first storing unit further stores a time stamp therein;
wherein the control unit allows the trace data and the time stamp to be stored in the second storing unit upon occurrence of the error.

4. The apparatus of claim 1, wherein the first storing unit further stores user setting information therein;
wherein the control unit allows the trace data and the user setting information to be stored in the second storing unit upon occurrence of the error.

5. The apparatus of claim 1, wherein, if the control unit receives a read command from a higher-level equipment, the control unit is configured to read the trace data stored in the second storing unit and send the trace data to the higher-level equipment.

6. A method of storing trace data for use in an image forming apparatus, the method comprising:
forming an image on a recording medium
generating trace data when the image forming apparatus is forming the image on the recording medium;
storing the trace data in a first storing unit; and
shifting the trace data stored in the first storing unit to a second storing unit upon occurrence of an error.

7. The method of claim 6, wherein the first storing unit includes a first and a second storing area,
wherein storing the trace data includes allowing the trace data to be stored in the first storing area of the first storing unit, upon occurrence of the error, and moving the trace data stored in the first storing area of the first storing unit to the second storing area of the first storing unit,
wherein the shifting includes moving the trace data stored in the second storing area of the first storing unit to the second storing unit.

8. The method of claim 6, wherein the first storing unit further stores a time stamp therein;
wherein storing the trace data includes allowing the trace data and the time stamp to be stored in the second storing unit upon occurrence of the error.

9. The method of claim 6, wherein the first storing unit further stores user setting information therein;
wherein storing the trace data includes allowing the trace data and the user setting information to be stored in the second storing unit upon occurrence of the error.

10. The method of claim 6, further comprising: receiving a read command from a higher-level equipment, the shifting includes reading the trace data stored in the second storing unit and send the trace data to the higher-level equipment.

11. A computer-readable storage medium storing instructions that, when executed by a computer, cause the computer to perform the operations of:
forming an image on a recording medium
generating trace data when the image forming apparatus is forming the image on the recording medium;
storing the trace data in a first storing unit; and
shifting the trace data stored in the first storing unit to a second storing unit upon occurrence of an error.
